(19) United States
(12) Patent Application Publication
(10) Pub. No.: US 2014/0227928 A1
(43) Pub. Date: Aug. 14, 2014

(54) COMPOSITE MATERIAL AND METHOD FOR PRODUCING SAME

(71) Applicants: Hubert Ehbing, Shanghai (CN); Reinhard Albers, Leverkusen (DE); Bernd Rothe, Koln (DE); Hans-Guido Wirtz, Leverkusen (DE)

(72) Inventors: Hubert Ehbing, Shanghai (CN); Reinhard Albers, Leverkusen (DE); Bernd Rothe, Koln (DE); Hans-Guido Wirtz, Leverkusen (DE)

(73) Assignee: Bayer Intellectual Property GmbH, Monheim (DE)

(21) Appl. No.: 14/342,166

(22) PCT Filed: Aug. 27, 2012
(86) PCT No.: PCT/EP2012/066601

§ 371 Date: Feb. 28, 2014

(30) Foreign Application Priority Data
Sep. 2, 2011 (DE) 10 2011 082 076.0

(51) Int. Cl. B32B 17/10

(52) U.S. Cl. CPC B32B 17/1077; B32B 17/10816
USPC 442/328; 442/373; 65/36

(57) ABSTRACT

The invention relates to a composite material made of a layer of inorganic, non-metal material and a sandwich element, and to a method for producing said composite material.

The present invention relates to a composite material consisting of a layer of inorganic non-metallic material and a sandwich element and also to a method for producing same.

Composite materials are made by combining two or more constituent materials. The geometric properties of the individual constituents may be important for the properties of the composite material as well as the properties of the constituent materials themselves. This makes it possible to combine properties of different constituents, as a result of which the composite materials have a broad spectrum of possible uses. The properties needed for the end product can be established as desired via the choice of different starting materials for the constituents.

Composite materials are obtainable in various ways. Sandwich construction is one possibility. This form of construction is frequently employed for intermediate articles where two or more layers having different properties are embedded in one material. Sandwich construction is a form of lightweight construction where the structural component parts consist of typically force-absorbing skin plies spaced apart by a usually lightweight core material (the spacer). Sandwich-structured parts are low in weight yet high in bending stiffness.

The core material can consist of honeycombed or porous structures in different materials, for example paper, paperboard, plastics or metals, balsa wood, corrugated sheet metal or foams. The core material transmits any shear forces and supports the skin layers.

Applications for sandwich-structured composite materials include, for example, sports boats, airplane parts (fuselage, wing shells), exterior and interior parts of railroad wagons, vehicle and automobile parts, surfboards and rotor blades for wind power systems, building exterior and mirror component parts in building construction and other fields of use.

Sandwich panels having a honeycombed core of aramid fibers and skin plies formed from glass fiber prepregs are also used as walls for on-board kitchens and toilets in state-of-the-art airplanes.

Sandwich composites used in building construction are prefabricated sandwich slabs having a backing shell of reinforced concrete, a layer of thermal insulant and a facing shell of clinker or concrete. In addition, composites having metallic skin layers and a thermal insulant in-between are referred to as a sandwich element or as a sandwich panel.

This form of construction is already being very widely used in shipbuilding, particularly for sports boats. Sandwich construction offers more safety in large-ship building, especially for tankers.

Sandwich construction is also used in automotive engineering. Strength is thus not compromised at low weight. The production of a fiber-reinforced plastics sandwich-type component part is known for example from DE 10 057 365 A1.

WO 2006/099939 A1 and WO 2009/043446 A2 disclose roof modules for motor vehicles, which are based on a sandwich method of construction. A sandwich consists of a spacer having a skin ply on both sides. A polyurethane is the connection between the spacer and the skin ply. Honeycomb structures or corrugated metal sheets are frequently used as spacers in these sandwich elements. The sandwich typically has an outer/functional layer on both sides. This outer layer frequently consists of polymeric film/sheet. This film/sheet is typically bonded into the sandwich under heat and pressure. The structure of the spacer frequently shows up on the surface of the film/sheet, so the surface of the sandwich element is no longer smooth. The structure of the spacer then also shows up in the end product.

When such a sandwich element is used as a building product which is visible later, such an irregular surface is frequently undesirable.

Irregular surfaces due to honeycomb structures can be prevented by using a foamed plastic as the spacer. The foamed plastic used must ideally be air-permeable in order that trapped air may escape into the foam layer during the manufacturing process. Such a use of open-cell foamed cores is already known from DE-A-10000767.

The problem with using a correspondingly lightweight foamed core is the retention of the required compressive strength and the avoidance of delamination effects between the core ply and the skin ply and also between the skin ply and the functional layer.

WO 2006/099939 A1 and WO 2009/043446 A2 disclose a polyurethane system for connecting the different plies which is unsuitable for use in large components, since its cream time is too short. The production of large components necessitates a specially conformed chemistry on the part of the polyurethane system, since otherwise the reaction of the polyurethane starts even as the skin layers are being sprayed, producing unwanted intrinsic stresses in the component as a result. A conformed cream time—to be understood as meaning the time interval between introduction of the reaction mixture and the starting of the chemical reaction—is therefore required. In the case of water-containing polyurethane reaction mixtures, visually discernible creaming is deemed to signal the start of the reaction.

However, to safeguard the economic viability of the process, a short demolding time has to be possible for the component. The demolding time is by definition the time needed by the reaction mixture of polyisocyanate and polyaddition products in the reaction mold to achieve a sufficiently high degree of crosslinking to enable proper removal of the composite material from the mold.

To produce large structural components, the polyurethane system has to be formulated with a retarded cream time. This ensures that the entire fibrous structure can be sprayed without premature creaming and excessively rapid through-reaction preventing uniform wetting of the fibrous structure. The combination of retarded cream time and short demolding time requires a polyurethane system chemistry specifically adapted to the process.

It is an object of the present invention to provide a composite material which is obtainable in sandwich construction and avoids the disadvantages of the prior art. More particularly, such a composite material shall have even over large areas a smooth surface where the structure of the spacer is not visible. The surface should be very smooth and be free of any indentations, air inclusions or similar defects. The surface of the sandwich element should be so planar that even functional elements can be secured thereto without their being damaged straight away by the sandwich element and/or the spacer showing through. A further object is the provision of large-area component parts of low weight to minimize the technical requirements of both fabrication and installation and afford a high degree of design freedom (e.g., bending, attachment of fixtures).

It was found that, surprisingly, the object is achieved by a combination of a stable lightweight substructure (sandwich element) with a layer of inorganic non-metallic material, especially a ceramic/glassy layer.

The invention accordingly provides a composite material consisting of A) a layer of inorganic non-metallic material and B) a sandwich element, wherein the sandwich element includes
a) at least one spacer composed of a foamed plastic,
b) on that side of the spacer which faces said layer (A) at least one layer of completely cured polyurethane and a polyurethane-permeable substrate from the group consisting of wovens, knits, nonwovens, scrims and mats of plastic, glass and/or carbon, and
c) on that side of the spacer which faces away from said layer (A) at least one layer of completely cured polyurethane reinforced with glass fiber mats and having a glass fiber content of at least 20 wt %, preferably at least 30 wt %, based on the layer facing away from said layer (A).

The composite material may preferably include an additional elastic layer C) between A) and B).

The foamed plastic preferably has an apparent density of 10 to 150 kg/m³.

The polyurethane of side (b) and/or (c) is preferably obtainable from a reactive polyurethane mixture which contains one or more aminosilanes as internal adhesion promoters and/or one or more internal release agents.

The polyurethane of side (b) and/or (c) is more preferably obtainable from a reactive polyurethane mixture in the presence of one or more latent catalysts.

The invention further provides a method for producing the composite material which is in accordance with the present invention, characterized in that
i) a layer (A) of inorganic non-metallic material is inserted into an open mold,
ii) an incompletely cured sandwich element (B) is placed on said layer (A) from i), wherein the sandwich element includes
   a) at least one spacer composed of a foamed plastic,
   b) on that side of the spacer which faces said layer (A) at least one layer of incompletely cured polyurethane and a polyurethane-permeable substrate from the group consisting of wovens, knits, nonwovens, scrims and mats of plastic, glass and/or carbon, and
   c) on that side of the spacer which faces away from said layer (A) at least one layer of incompletely cured polyurethane reinforced with glass fiber mats and having a glass fiber content of at least 20 wt %, preferably at least 30 wt %, based on the layer facing away from said layer (A),
iii) the mold is closed,
iv) the polyurethane is cured with or without heating and the layered construction is pressed with or without heating and with or without application of a vacuum,
v) the mold is opened and the shaped, cured and optionally pressed composite material is removed from the mold.

Steps (i) and (ii) can also be carried out in the reverse order.

In a preferred embodiment of the method, an elastic layer is applied (by spraying, for example) to said layer (A) prior to step ii).

Sandwich element (B) can be inserted into the mold as a prefabricated element. To fabricate the sandwich element outside the mold, the corresponding glass fiber mat on one side of the core (spacer) and the corresponding permeable substrate on the other side of the core are sprayed with reactive polyurethane mixture and subsequently placed on layer (A) in the mold.

The composite materials of the present invention can be used as a roof module, as a chassis part, as a structural part in vehicle, ship or aircraft construction, as a cladding element or decorative element or as a building exterior and mirror component part in building construction, or other applications.

Useful core spacers include, for example, open-cell rigid-foam cores based on polyurethane. Useful spacers/cores further include, for example, open-pore or open-cell (reticulated, for example) polyvinyl chloride (PVC), polyethylene (PE), polypropylene (PP), polyethylene terephthalate (PET), polybutylene terephthalate (PBT), polystyrene (PS), expanded polystyrene (EPS) or crosslinked polystyrene (XPS) foams or else open-cell metallic or ceramic foams.

Such an open-pore/open-cell rigid foam preferably has an apparent density in the range from 10 to 150 kg/m³, preferably in the range from 20 to 100 kg/m³ and more preferably in the range from 30 to 60 kg/m³ (when measured to DIN EN ISO 845). These rigid foams more preferably have an open-cell content of ≧10%, preferably ≧12%, more preferably ≧15% (when measured to DIN EN ISO 4590-86).

From experience, rigid (polyurethane) foams having apparent densities >150 kg/m³ are closed-cell. Open-cell foams having higher apparent densities and stiffnesses/strengths are also obtainable via an additional operation (an example being reticulation=the intentional opening of the foam by negative or positive pressure in an autoclave). Use of these open-cell foams may be preferable. A closed-cell foam can further be given an open structure by secondary mechanical finishing (by aperturing the surface, for example).

The advantage of the composite material according to the present invention over composite materials described in the prior art is that, when it is used for example as rear side covering as roof module, building exterior element or other component parts, any air trapped in the course of the manufacturing process can escape via the open-cell foamed plastic and/or be absorbed by the latter.

It is known from existing methods for producing composite elements that, typically, the sandwich element is presented first and a decorative and/or functional layer is applied to it via possible adhesive layers. As this decorative and/or functional layer is being applied, there is air between it and the sandwich element underneath. To composite them together, then, a pressure or else possibly also a vacuum is applied with or without heating. In the case of small-area composite materials, then, the air can escape via the edges. With large-area composites, however, this is not possible. Air therefore remains trapped between the sandwich element and the functional and/or decorative layer. This does not happen with the method of the present invention.

The design of the spacer in a sandwich element of the present invention is such that the air can be absorbed by or escape via the open cells of the rigid foam. Air entrapments between the sandwich element and layer A) are avoided as a result.

The skin layers of the spacer are sprayed with a polyurethane resin which enables homogenous bonding of the composite material. The pressing operation involved in the fabrication process additionally presses some of the polyurethane resin into the open-cell outer region of the core ply. This additionally serves to prevent later delamination of the skin ply from the core ply. At the same time, moreover, the compressive strength of the core ply and hence the bending stiffness of the sandwich is enhanced.

The fact that portions of the polyurethane resin can be pressed into the core ply further results in a very uniform distribution for the polyurethane matrix between layer A) and the sandwich—thus evening out any distribution differences resulting from the sprayed application.

The polyurethane resin used is obtainable by reaction of
a) at least one polyisocyanate,
b) at least one polyol component having an average OH number of 300 to 700 and containing at least one short-chain polyol and one long-chain polyol, wherein the starting polyols have a functionality of 2 to 6,
c) water,
d) activators,
e) stabilizers,
f) optionally auxiliary, release and/or adjunct agents
g) optionally organic and inorganic acids.

The preferred long-chain polyols are polyols having at least two to at most six isocyanate-reactive hydrogen atoms; preference is given to using polyester polyols and polyether polyols having OH numbers of 5 to 100, preferably 20 to 70, more preferably 28 to 56.

The preferred short-chain polyols have OH numbers of 150 to 2000, preferably 250 to 1500 and more preferably 300 to 1100.

Preference for use in the present invention is given to comparatively high-nuclear isocyanates of the diphenylmethane diisocyanate series (pMDI types), their prepolymers or blends of these components.

Water is used in amounts of 0 to 3.0, preferably 0 to 2.0 parts by weight per 100 parts by weight of polyol formulation (components b) to g)).

Catalysts used are the customary activators for the blowing and crosslinking reactions, for example amines or metal salts. Tertiary amines and/or organometallic compounds can be used, for example. Useful catalysts include, for example, the following compounds which are familiar to a person skilled in the art: triethylenediamine, aminoalkyl- and/or aminophenylimidazoles and/or organic carboxylic acid salts. Metal catalysts useful for the purposes of the present invention also include metal compounds of tin, of titanium and/or of bismuth. The catalysts are typically used in amounts of 0.2-4 wt % based on the weight of component b).

The preferred foam stabilizers are polyether siloxanes, preferably water-soluble components. The stabilizers are typically used in amounts of 0.01 to 5 parts by weight, based on 100 parts by weight of the polyol formulation (components b) to g)).

The reaction mixture for producing the polyurethane resin may optionally be admixed with auxiliary, release and adjunct agents, for example surface-active adjunct substances, e.g., emulsifiers, flame retardants, nucleators, antioxidants, slip and demolding agents, dyes, dispersants, blowing agents and pigments.

The reaction mixture may optionally contain known organic or inorganic acids (component g)), in particular inorganic or organic acids useful for blocking basic catalysts, especially tertiary amines. Phosphoric acid, acetic acid and/or aqueous polyacrylic acid are useful, for example. The components are preferably employed in a proportion of 0.05 wt % to 0.8 wt %, preferably 0.05 wt % to 0.1 wt %, based on the overall weight of the polyol formulation (components b) to g)).

The components are made to react in such amounts that the equivalence ratio of the NCO groups of polyisocyanates a) to the sum total of isocyanate-reactive hydrogens of components b) and c) and optionally d), e) and f) is in the range from 0.8:1 to 1.4:1 and preferably in the range from 0.9:1 to 1.3:1.

The polyurethane-permeable substrate may consist for example of glass fiber mats, glass fiber nonwovens, random-laid glass fiber plies, woven glass fiber fabrics, chopped or ground glass fibers, chopped or ground mineral fibers, natural fiber mats and knits, chopped natural fibers and also fibrous mats, nonwovens and knits based on polymer/carbon/aramid fibers and also their mixture.

The fibrous layer endows the foamed-plastic spacer with the stiffness ultimately needed in the final product. The fibrous layer is also air-permeable.

The elastic layer C) between layer A) and sandwich element B), its composition and its method of making are exhaustively described in DE-A 102005012 796.

Layer (A) can utilize inorganic non-metallic materials. Glass, marble or other inorganic non-metallic materials can be used as layer. A plate or foil in this case can be used as layer A). The layers A) are commercially available, and their method of making is common general knowledge. In general, layer A) has a thickness of 0.2 to 4 mm, preferably of 0.5 to 1.5 mm and more preferably of 0.75 to 1.1 mm.

A transparent protective layer, for example in the form of a lacquer or of a plasma layer, may preferably be additionally applied to the outer side of layer A). This additional protective layer is responsible for protecting against external influences.

The inner side (underside) of layer A), the side which is oriented toward the sandwich element, may have a conformed adhesion promoter applied to it. Such a measure can endow layer A) with an additional, improved adherence to the skin layer of the sandwich element or, if present, to elastic layer C), and/or with a heat- and/or moisture-barring function.

A protective layer can be applied to the reverse side of the sandwich element, the side which faces away from layer A). This additional protective layer is responsible for protecting against external influences.

The composite material of the present invention may preferably be equipped with a frame. Such a frame protects the spacer from moisture, air or other environmental effects which can get in through the sides which are not covered with the polyurethane layers. The quality of the entire sandwich element can be severely impaired by the ingress of moisture. A homogeneous surface and the associated good visual appearance/good adherence of layer (A) is no longer ensured in such an event. Such influences are prevented by an appropriate frame.

To carry out the method of the present invention,
i) the sandwich element is initially charged to an open mold,
ii) optionally an additional elastic layer in the form of a polymeric film/sheet or as a compound is applied to a free area of the sandwich element,
iii) the layer (A) with or without an applied adhesion promoter is applied,
iv) the mold is closed,
v) the polyurethane is cured with or without heating and this layered construction is pressed with or without heating and with or without application of a vacuum, and
vi) the mold is opened and the shaped, cured composite material is removed from the mold.

Alternatively, the order of presenting the individual layers can also be changed.

In another embodiment of the method for producing a composite material in the manner of the present invention,
i) the layer (A) with or without an applied adhesion promoter is inserted into an open mold,
ii) optionally an elastic layer (C) is applied to said layer (A) in the form of a polymeric film/sheet or as a compound,
iii) a sandwich element is applied,
iv) the mold is closed,
v) the polyurethane is cured with or without heating and this layered construction is pressed with or without heating and with or without application of a vacuum, and
vi) the mold is opened and the shaped, cured composite material is removed from the mold.

In the course of the fabrication process, different fixture elements can be integrated in the sandwich construction. These elements can be additionally applied to the reverse side of the sandwich element, so the spraying with reactive polyurethane mixture will produce a firm bond. The fixture elements may likewise be bonded to the sandwich via additional glass fiber usage and additional polyurethane.

The composite materials of the present invention can be used as a roof module, as a chassis part, as a structural part in vehicle, ship or aircraft construction, as a cladding element or decorative element or as a building exterior and mirror component part in building construction, or other applications.

The invention will now be more particularly elucidated by the following examples:

### EXAMPLES

### Working Example (1):

The sandwich element used was a Baypreg® sandwich (from Bayer MaterialScience AG). This sandwich consists of two different skin layers and a core of foamed plastic, which are bonded to each other by means of a sprayed-on polyurethane (Baypreg®).

The sandwich element was produced by providing a polystyrene board (from Philippine GmbH & Co. Dämmstoffsysteme KG, Bochum, type PH-WDV 60/040, thickness 20 mm) and placing on its top side (which is oriented toward layer A)) a random-laid glass fiber mat having a basis weight of 225 g/m² (type M-113 from Saint-Gobain Vetrotex Deutschland GmbH, Aachen) and on its underside (the side which faces away from layer A)) a random-laid glass fiber mat having a basis weight of 450 g/m² (type M 5, from Saint-Gobain Vetrotex Deutschland GmbH, Aachen).

This construction was then sprayed on both sides with 450 g/m² of a reactive polyurethane system using a high-pressure processing machine. The polyurethane system used came from Bayer MaterialScience AG, Leverkusen, and consisted of a polyol (Baypreg® VP.PU PR-02831-01) and an isocyanate (Desmodur® VP.PU 081F03) in a mixing ratio of 100 parts by weight to 204 parts by weight.

The sandwich element formed from the polystyrene board as spacer and from the polyurethane-sprayed skin layers was transferred into a molding press which already contained, on the underside, the previously inserted inorganic non-metallic layer A). The inorganic non-metallic layer is a glass pane 0.95 mm in thickness.

The mold was heated to 90° C. and the construction was pressed for 300 seconds to form a composite element 18 mm in thickness.

### Working Example (2):

The sandwich element used was a Baypreg® sandwich from Bayer MaterialScience AG. This sandwich consists of two different skin layers and a core of foamed plastic, which are bonded to each other by means of a sprayed-on polyurethane (Baypreg®). In addition, the side facing layer A) was sprayed with an elastic layer of polyurethane in a thickness of one millimeter.

The first component inserted into the opened mold was the inorganic non-metallic layer A) (glass having a thickness of 0.95 mm).

Thereafter to produce elastic layer C) in a thickness of one millimeter, a reactive polyurethane mixture was sprayed onto layer A). The mixture consists of a polyol (Bayflex® VP.PU 51BD14) and an isocyanate (Desmodur® VP.PU 181F19) from Bayer MaterialScience AG, Leverkusen.

For sandwich production, first the top and bottom sides of a polystyrene board (from Philippine GmbH & Co. Dämmstoffsysteme KG, Bochum, type PH-WDV 60/040, thickness 10 mm) were each covered with a random-laid fibrous mat of the M 113 type having a basis weight of 225 g/m² (from Saint-Gobain Vetrotex Deutschland GmbH, Aachen).

This construction was then sprayed on both sides with 450 g/m² of a reactive polyurethane system using a high-pressure processing machine. The polyurethane system used came from Bayer MaterialScience AG, Leverkusen, and consisted of a polyol (Baypreg® VP.PU PR-02831-01) and an isocyanate (Desmodur® VP.PU 081F03) in a mixing ratio of 100 parts by weight to 204 parts by weight.

The sandwich element formed from the polystyrene board as spacer and from the polyurethane-sprayed skin layers was transferred into a molding press which already contained, on the underside, the previously inserted layer A) plus elastic layer C). The mold was heated to 90° C. and the construction was pressed for 300 seconds to form a composite element 11 mm in thickness.

The component parts obtained after the production process are free of any distortion or any delamination between layer A) and the sandwich element. Nor is there any delamination after a climate cycling test, which layer A) also survives intact across the full surface. The surface remains free of any blemishes.

1-12. (canceled)

13. A composite material consisting essentially of A) a layer of inorganic non-metallic material and B) a sandwich element, wherein the sandwich element includes
a) at least one spacer composed of a foamed plastic,
b) on that side of the spacer which faces said layer (A) at least one layer of completely cured polyurethane and a polyurethane-permeable substrate from the group consisting of wovens, knits, nonwovens, scrims and mats of plastic, glass and/or carbon, and
c) on that side of the spacer which faces away from said layer (A) at least one layer of completely cured polyurethane reinforced with glass fiber mats and having a glass fiber content of at least 20 wt %, based on the layer facing away from said layer (A).

14. The composite material as claimed in claim 13, wherein the composite material includes an additional elastic layer C) between A) and B).

15. The composite material as claimed in claim 13, wherein the composite material includes an additional adhesion-promoting layer D) between A) and B) or between A) and C), if present.

16. The composite material as claimed in claim 13, wherein the foamed plastic has an apparent density of 10 to 150 kg/m³.

17. The composite material as claimed in claim 13, wherein the polyurethane of side (b) and/or (c) is obtainable from a reactive polyurethane mixture which contains one or more aminosilanes as internal adhesion promoters.

18. The composite material as claimed in claim 13, wherein the polyurethane of side (b) and/or (c) is obtainable from a reactive polyurethane mixture which contains one or more internal release agents.

19. The composite material as claimed in claim 13, wherein the polyurethane of side (b) and/or (c) is obtainable from a reactive polyurethane mixture in the presence of one or more latent catalysts.

20. A method for producing the composite material as claimed in claim claim 13, which comprises
i) inserting a layer (A) of inorganic non-metallic material with or without an applied adhesion promoter into an open mold,
ii) placing incompletely cured sandwich element (B) on said layer (A) from i), wherein the sandwich element includes
a) at least one spacer composed of a foamed plastic,
b) on that side of the spacer which faces said layer (A) at least one layer of incompletely cured polyurethane and a polyurethane-permeable substrate from the group consisting of wovens, knits, nonwovens, scrims and mats of plastic, glass and/or carbon, and
c) on that side of the spacer which faces away from said layer (A) at least one layer of incompletely cured polyurethane reinforced with glass fiber mats and having a glass fiber content of at least 30 wt %, based on the layer facing away from said layer (A),
iii) closing the mold,
iv) curing the polyurethane with or without heating and the layered construction is pressed with or without heating and with or without application of a vacuum,
v) the mold is opened and the shaped, cured and pressed composite material is removed from the mold.

21. The method as claimed in claim 20, wherein an elastic layer (C) is applied to said layer (A) prior to step ii).

22. The method as claimed in claim 20, wherein an adhesion promoter is applied to said layer (A) prior to step ii).

23. A method for producing a composite material as claimed in claim 13, which comprises
i) inserting an incompletely cured sandwich element (B) into an open mold, wherein the sandwich element includes
a) at least one spacer composed of a foamed plastic,
b) on that side of the spacer which faces said layer (A) at least one layer of incompletely cured polyurethane and a polyurethane-permeable substrate from the group consisting of wovens, knits, nonwovens, scrims and mats of plastic, glass and/or carbon, and
c) on that side of the spacer which faces away from said layer (A) at least one layer of incompletely cured polyurethane reinforced with glass fiber mats and having a glass fiber content of at least 30 wt %, based on the layer facing away from said layer (A),
ii) optionally an additional elastic layer (C) in the form of a polymeric film/sheet or as a compound is applied to the free area of the sandwich element,
iii) then a layer A) of inorganic non-metallic material with or without an applied adhesion promoter is applied,
iv) the mold is closed,
v) the polyurethane is cured with or without heating and the layered construction is pressed with or without heating and with or without application of a vacuum,
vi) the mold is opened and the shaped, cured and pressed composite material is removed from the mold.

24. A method of using a composite material as claimed in claim 13 as a roof module, as a chassis part, as a structural part in vehicle, ship or aircraft construction, as a cladding element or decorative element or as a building exterior and mirror component part in building construction.
